(19) United States
(12) Patent Application Publication
(10) Pub. No.: US 2026/0249254 A1
(43) Pub. Date: Aug. 27, 2026

(54) Method and System for Azeotropic Separation Using Organophobic Ceramic Membranes

(71) Applicant: Felipe Lembcke, Granbury, TX (US)

(72) Inventor: Felipe Lembcke, Granbury, TX (US)

(73) Assignee: Molecular Filtration, Inc., Granbury, TX (US)

(21) Appl. No.: 19/060,563

(22) Filed: Feb. 21, 2025

(51) Int. Cl. B01D 71/02; B01D 53/22

(52) U.S. Cl. CPC B01D 71/025; B01D 53/228; B01D 71/0215; B01D 71/027; B01D 2257/2064; B01D 2257/40; B01D 2325/02832; B01D 2325/02833

(57) ABSTRACT

This invention describes a method for azeotropic separation using an organophobic ceramic membrane. The membrane blocks non-polar compounds while allowing polar compounds to pass, enabling efficient separation without heat or entrainers. The membrane is made of Al₂O₃, SiO₂, MgO, SiC, or MnO, with pore sizes from 1 to 200 nanometers, and may be flat, tubular, or geometrically configured. Applications include refining, biofuels, pharmaceuticals, and chemical processing. The process operates continuously, avoids distillation, and reduces energy costs. Laboratory results confirm removal of C6-C12 non-polar organics from azeotropic mixtures while preserving polar solvents. This technology simplifies complex separations and offers a sustainable alternative to traditional methods.

### FIELD OF THE INVENTION

This invention relates to the separation of azeotropic mixtures, particularly through a novel membrane-based molecular filtration system. It replaces conventional azeotropic distillation methods by utilizing organophobic ceramic membranes that reject non-polar compounds while allowing polar compounds to permeate.

### Reference to Prior Patent

The present invention is an extension of the organophobic ceramic membrane technology previously disclosed in WO 2015/066347 A1 (Felipe Lembcke & Eduardo Gómez Maqueo Arechiga). In the prior patent, a functionalized porous ceramic membrane was introduced to selectively separate non-polar organic compounds from a liquid feed, enabling high-efficiency filtration.

This current invention expands upon that foundation by applying the membrane technology to azeotropic separation, a problem traditionally solved by energy-intensive distillation methods. Unlike conventional separation techniques, which rely on pressure swing, extractive distillation, or molecular sieves, this new method exploits the membrane's ability to selectively reject non-polar organics, enabling molecular-level filtration with near-total separation efficiency.

This represents a fundamental advancement in separation science, transforming azeotropic purification processes across, but not limited to: refining, biofuels, chemical manufacturing, pharmaceutical applications, and other industries where azeotropic separation is required.

### BACKGROUND OF THE INVENTION

Traditional azeotropic separation relies on energy-intensive distillation methods, including pressure-swing and extractive distillation. These approaches require significant thermal input, additional solvents, and complex operations. Several prior patents, such as U.S. Pat. Nos. 2,265,939A, 2,809,925A, 5,993,610A, describe such distillation-based methods.

The present invention overcomes these limitations by introducing a membrane-based separation process that leverages molecular polarity differences. This enables near-total efficiency in separating polar and non-polar azeotropic components, reducing energy consumption and process complexity.

### SUMMARY OF THE INVENTION

The disclosed system utilizes an organophobic ceramic membrane to separate azeotropic mixtures without requiring thermal phase changes. The process consists of:
1. Introducing an azeotropic mixture into the membrane system.
2. Selectively rejecting non-polar components while allowing polar components to permeate.
3. Collecting the permeate without requiring distillation or entrainers.
4. Achieving separation efficiencies approaching 100%, particularly for non-polar compounds with a dipole moment near zero.

Detailed Description of the Invention [0019] The membrane system consists of an organophobic ceramic membrane that can take various geometries to suit different applications. These geometries include, but are not limited to, tubular membranes with multiple channels, flat sheet membranes, and membranes with different external shapes such as circular, hexagonal, or other geometric figures. The tubular membranes may contain varying numbers of channels, which can be circular, hexagonal, or shaped in other geometric forms depending on the intended use. Likewise, the external shape of the membrane itself can vary to include hexagonal, circular, or other geometric profiles. The selection of membrane configuration depends on the specific molecular filtration process and its operational requirements, allowing for versatility in industrial applications. The membrane materials include Al₂O₃, SiO₂, MgO, SiC, MnO, or other suitable ceramics, with pore sizes ranging from 1 to 200 nanometers to enable selective molecular filtration. This broader pore size range is supported by performance data indicating enhanced permeate flow without compromising separation efficiency. This design flexibility ensures that the organophobic ceramic membrane can be optimized for various applications, enhancing separation efficiency and accommodating diverse process conditions.

The membrane system consists of a multichannel organophobic ceramic membrane composed of materials such as Al₂O₃, SiO₂, MgO, SiC, or MnO. The pore size ranges from 1 to 200 nanometers, ensuring selective molecular filtration. Unlike conventional membranes that allow partial diffusion of non-polar organics, this membrane technology entirely blocks non-polar components, enabling precise azeotropic separation.

### Industrial Applications

This process is applicable in various industries, including but not limited to:
Oil Refining (hydrocarbon separation)
Chemical Processing (solvent recovery)
Biofuels (ethanol purification)
Pharmaceuticals (solvent separation for high-purity applications)

Figures & Schematics1. Process Flow Diagram-Illustrating azeotropic separation using the membrane.2. Membrane Cross-Section-Depicting channel geometry variations, including circular, hexagonal, and other shapes.3. Efficiency Graph—Comparing membrane performance with traditional distillation, highlighting near 100% efficiency.

1. Process Flow Diagram as shown in

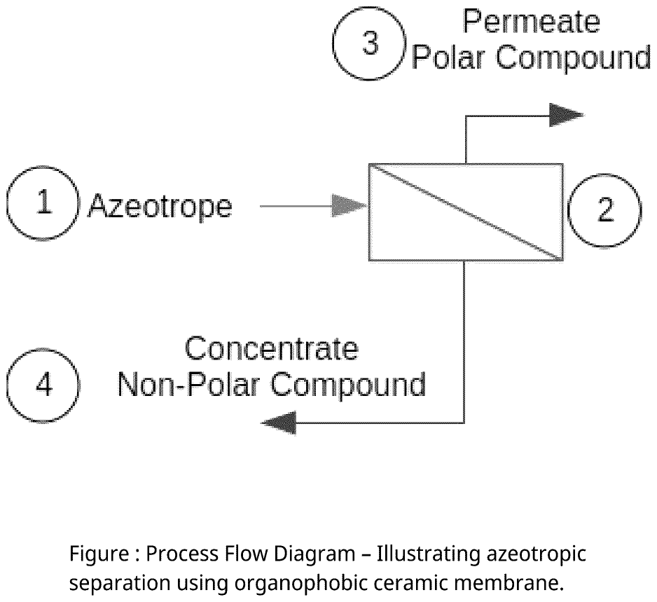

FIG. 1.-Illustrating azeotropic separation using the membrane.
2. Membrane Cross-Section as shown in

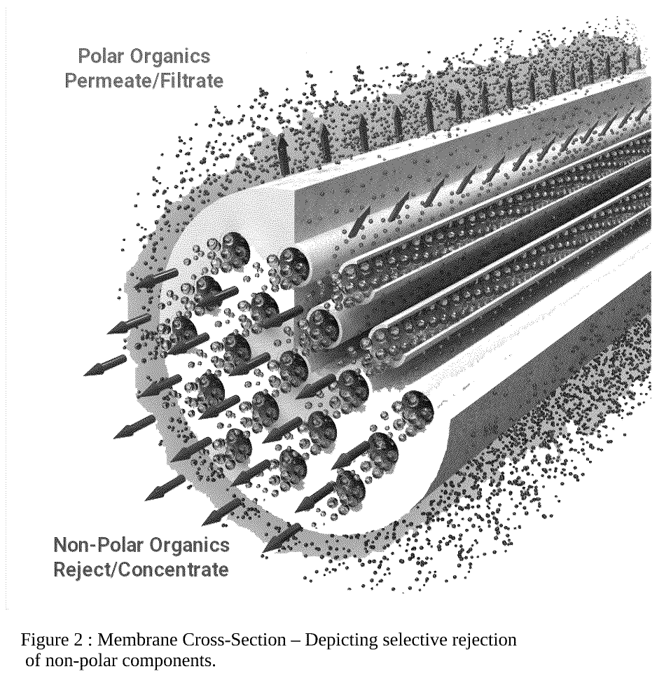

FIG. 2.-Depicting selective rejection of non-polar components.
3. Efficiency Comparison Graphs as shown in

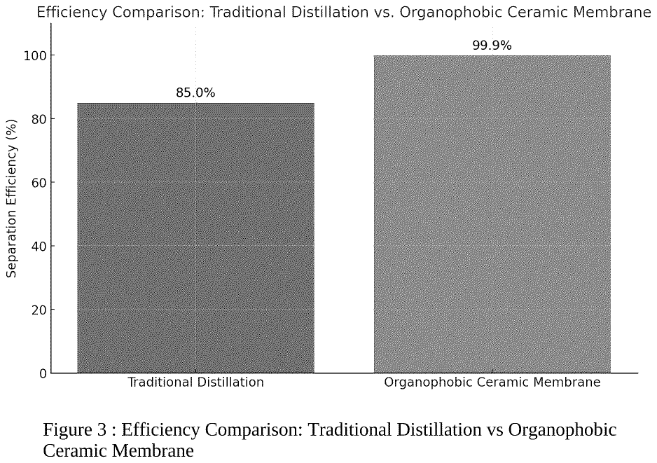

FIG. 3.-Efficiency Comparison: Traditional Distillation vs Organophobic Ceramic Membrane

### PROCESS DESCRIPTION

Feed Introduction (Stream No. 1-Azeotrope): The azeotropic mixture, consisting of both polar and non-polar compounds, is pumped into the system through Stream No. 1. The pump ensures a controlled feed pressure for optimal membrane separation performance.

Membrane Separation Unit (No. 2-Molecular Filtration Ceramic Membrane): The feed stream enters the Molecular Filtration unit containing the proprietary organophobic ceramic membrane. This membrane selectively allows polar compounds to permeate through while rejecting non-polar compounds.

Permeate Stream (Stream No. 3-Polar Compound): The polar component, which is not retained by the membrane, passes through as the permeate. This stream is collected as Stream No. 3, representing the purified polar compound.

Concentrate Stream (Stream No. 4-Non-Polar Compound): The non-polar component is rejected by the membrane and exits as the concentrate stream (Stream No. 4). This stream contains the enriched non-polar compound separated from the azeotropic mixture.

### Key Advantages of the Process:

Energy Efficiency: No heating is required, reducing operational costs and preserving thermally sensitive materials.
Selective Separation: The organophobic membrane ensures high selectivity between polar and non-polar components.
Simplicity and Reliability: The process involves minimal equipment, reducing maintenance needs.
Environmental Benefits: Lower energy usage translates to a smaller carbon footprint.

Operational Considerations:-Operating pressure is determined based on the specific azeotropic mixture and desired separation efficiency.—No temperature control is required, simplifying the process design.-Membrane cleaning protocols, including frequency and chemical compatibility, should be established based on operating conditions.
Operating pressure is determined based on the specific azeotropic mixture and desired separation efficiency.
No temperature control is required, simplifying the process design.
Membrane cleaning protocols should be followed to maintain long-term performance.

Refer to the accompanying Process Flow Diagram for a visual representation of the described process.

### Proof of Performance

Proof of performance for Total Petroleum Hydrocarbon (TPH) Concentrations (mg/L) in Feed, Permeate, and Concentrate Samples as shown in Table 1. Original water analysis from a certified laboratory are attached to patent application.

TABLE 1
TPH Concentrations (mg/L) in Feed,
Permeate, and Concentrate Samples.

| | C6-C12 | C12-C28 | C28-C35 |
|---|---|---|---|
| Sample | (mg/L) | (mg/L) | (mg/L) |
| Feed | 1860 | 3180 | 823 |
| (3039270) | | | |
| Permeate | <1.05 | <0.96 | <1.13 |
| (3039270) | | | |
| Concentrate | 1290 | 2410 | <1.13 |
| (3039270) | | | |
| Feed | 89.6 | 218 | <0.04 |
| (3G00045) | | | |
| Permeate | <0.04 | <0.04 | <0.04 |
| (3G00045) | | | |
| Concentrate | 106 | 306 | <0.05 |
| (3G00045) | | | |

1. A method for azeotropic separation using an organophobic ceramic membrane, wherein:
A polar and non-polar component are introduced into the membrane system.
The non-polar component is completely rejected, while the polar component permeates.
The process applies to azeotropic mixtures including, but not limited to, ethanol/hexane, acetone/pentane, water/toluene, and acetic acid/benzene.
The method is applicable to any azeotropic mixture wherein the non-polar component has a dipole moment near zero.

2. The method of claim 1, wherein the membrane operates with a selectivity exceeding 99.9% for the polar component over the non-polar component.

3. The method of claim 1, wherein the membrane material is selected from Al₂O₃, SiO₂, MgO, SiC, or MnO.

4. The method of claim 1, wherein the membrane rejects inorganic compounds with a dipole moment near zero, including but not limited to carbon tetrachloride (CCl₄), sulfur hexafluoride (SF₆), nitrogen (N₂), and noble gases.
